(19) United States
(12) Patent Application Publication
(10) Pub. No.: US 2013/0154536 A1
(43) Pub. Date: Jun. 20, 2013

(54) APPARATUS FOR CONTROLLING AN INVERTER

(71) Applicant: LSIS CO., LTD, Anyang-si (KR)

(72) Inventor: Jong Je PARK, Ansan-si (KR)

(73) Assignee: LSIS CO., LTD, Anyang-si (KR)

(21) Appl. No.: 13/708,851

(22) Filed: Dec. 7, 2012

(30) Foreign Application Priority Data
Dec. 14, 2011 (KR) 10-2011-0134207

(51) Int. Cl. H02P 23/00

(52) U.S. Cl. CPC H02P 23/0027
USPC 318/503; 318/504

(57) ABSTRACT

An apparatus for controlling an inverter is disclosed, the apparatus detecting a DC link voltage of the inverter and a load amount using an output current outputted from a motor to the inverter, and deducting a load amount detected at the time of occurrence of instantaneous power failure from a command frequency at the time of the occurrence of instantaneous power failure, whereby a command voltage and a command frequency driving the motor can be outputted.

### CROSS-REFERENCE TO RELATED APPLICATIONS

Pursuant to 35 U.S.C.§119 (a), this application claims the benefit of earlier filing date and right of priority to Korean Patent Application No. 10-2011-0134207, filed on Dec. 14, 2011, the contents of which is hereby incorporated by reference herein in its entirety.

### BACKGROUND OF THE DISCLOSURE

1. Field of Endeavor

The present disclosure relates to an apparatus for controlling an inverter.

2. Background

This section provides background information related to the present disclosure which is not necessarily prior art.

In general, a power inverter, or inverter, is an electrical power converter that changes DC (Direct Current) to AC (Alternating Current) at any required voltage and frequency through PWM (Pulse Width Modulation) switching operation by being connected to a three-phase commercial AC power source to generate a desired power and supplies the power to a motor, where the motor controlled by the inverter in turn generates a torque to drive a load.

Recently, performance and reliability of an inverter using a power conversion system have influentially mattered in industrial fields. In fact, as loads sensitive to power quality such as factory automation facilities and semiconductor facilities increase, reliability of an inverter is further emphasized.

FIG. 1 is a schematic configuration of a driving system of an inductive motor according to prior art and FIG. 2 is a block diagram illustrating a configuration of an inverter.

Referring to FIG. 2, a three-phase AC (Alternating Current) is rectified to a DC (Direct Current) by a rectifier, reduced in ripples by a smoother unit (120), and applied to an inverter unit (130).

At this time, a voltage detection unit (140) determines whether there is generated a momentary power failure using a DC link power of the smoother unit (120). That is, as a result of the determination of DC link voltage, if the DC link voltage is greater than a power failure reference voltage, a frequency generation unit (150) recognizes that the DC link voltage is not in a low voltage state, and outputs a frequency variable signal to the inverter unit (130) in response to a speed command. Furthermore, the inverter unit (130) is switched by the frequency variable signal to convert a DC link DC voltage to a three-phase AC voltage for application to an induction motor (200).

Meanwhile, as a result of the determination of DC link voltage, if the DC link voltage is smaller than a power failure reference voltage, a frequency generation unit (150) fails to receive a voltage from the voltage detection unit (140), whereby the inverter unit (130) cannot apply a driving voltage to the induction motor (200) side.

At this time, the induction motor (200) generates a predetermined torque according to the following Equation 1, and even at a state of the power being interrupted, maintains rotation for a predetermined time, i.e., an inertial energy of a load (300) being consumed as a friction load, and then stops.

$${T}_{m} = J \frac{d ω}{d t} + B ω + {T}_{L} [ Nm ] \qquad [ Equation 1 ]$$

where, J is an inertial moment of the motor (200) and the load (300), B is a frictional coefficient, ω is an angular velocity and T_{L} is a load torque.

Under a normal inverter operation state, an inverter output frequency gradually decreases due to a halt instruction of the inverter (100) to stop the induction motor (200), but if an unexpected power failure occurs due to power accident, the inverter interrupts an output, and stops after rotation for a predetermined time by an inertial energy of the induction motor.

The conventional induction motor (200) determines failure and stops an output if an unexpected power failure such as power accident occurs to render a DC link voltage of the smoother unit (120) to be less than a low voltage. At this time, a time of interrupting an output of the inverter (100) after interruption of input power is determined by a load quantity and capacity of a DC link capacitor of the inverter.

Return of an inertial energy of the load (300) to a DC link by controlling a DC link voltage of the inverter (100) is called voltage drop compensation. That is, the voltage drop compensation guarantees a controlled power of an inverter (100), even if there is an instantaneous power failure, to enable a continuous operation of the inverter (100) without any interruption of output.

If there is a power failure at an input terminal of the inverter (100), the DC link voltage decreases, which promptly leads to a LVT (Low Voltage Trip). In addition, even if the power is interrupted, rotation of the induction motor (200) is continued by the inertial energy of the load (300) for a predetermined time, such that, in order to restart the inverter (100), an operator must wait until the inverter (100) completely stops, which disadvantageously results in a very big loss for an inverter applied to important loads such as factory automation facilities or semiconductor facilities.

The voltage drop compensation is provided to solve the above-mentioned disadvantage, and maintains the DC link voltage above a power failure reference voltage in order to prevent the inverter from interrupting an output during generation of instantaneous power failure.

However, there is a disadvantage of being disabled to control an inverter by the conventional voltage drop compensation due to sudden drop of the DC link voltage when a load is applied.

Thus, there is a need to provide an apparatus for controlling an inverter capable of solving the aforementioned disadvantages or problems.

### SUMMARY OF THE DISCLOSURE

This section provides a general summary of the disclosure, and is not a comprehensive disclosure of its full scope or all of its features.

Methods and systems consistent with the present disclosure provide an apparatus for controlling an inverter configured to keep operating a motor without interruption during occurrence of instantaneous power failure and to safely interrupt the inverter after occurrence of power failure.

It should be emphasized, however, that the present disclosure is not limited to a particular disclosure as explained above. It should be understood that other technical subjects not mentioned herein may be appreciated by those skilled in the art.

In one general aspect of the present disclosure, there is provided an apparatus for controlling an inverter, the apparatus comprising: a first detection unit detecting a DC link voltage of an inverter; a second detection unit detecting a load amount from an output current outputted from the inverter to a motor; and a controller deducting the load amount detected at the time of occurrence of instantaneous power failure from a command frequency at the time of the occurrence of instantaneous power failure to output a command voltage and a command frequency driving the motor.

Preferably, but not necessarily, the controller controls a load amount for maintaining the DC link voltage during the occurrence of instantaneous power failure from below a power failure reference voltage to above a LVT (Low Voltage Trip) level.

Preferably, but not necessarily, the controller controls the motor in such a manner that a slip frequency of the motor comes near to zero (0).

Preferably, but not necessarily, the controller reduces a rotation speed of the motor by adjusting a ratio (V/F) between a command frequency and a command voltage, in a case the DC link voltage drops below a restoration reference voltage. Preferably, but not necessarily, the controller interrupts an output before the DC link voltage drops to below the LVT level.

The apparatus for controlling an inverter according to exemplary embodiments of the present disclosure has an advantageous effect in that a DC link voltage and a load amount are detected during occurrence of instantaneous power failure to enable an inverter to continuously operate, to enhance a control characteristic and to improve performance of an inverter system.

Another advantageous effect is that reliability of important facilities including process automation lines or semiconductor facilities that require reliability can be improved.

### BRIEF DESCRIPTION OF THE DRAWINGS

In order to explain the principle of the present disclosure, some accompanying drawings related to its preferred embodiments are below reported for the purpose of illustration, exemplification and description, although they are not intended to be exhaustive. The drawing figures depict one or more exemplary embodiments in accord with the present concepts, by way of example only, not by way of limitations. In the figures, like reference numerals refer to the same or similar elements.

Thus, a wide variety of potential practical and useful embodiments will be more readily understood through the following detailed description of certain exemplary embodiments, with reference to the accompanying exemplary drawings in which:

FIG. 1 is a schematic configuration of a driving system of an inductive motor according to prior art;

FIG. 2 is a block diagram illustrating a configuration of an inverter;

FIG. 3 is a schematic structural view of an inverter system of an inverter control device according to an exemplary embodiment of the present disclosure;

FIG. 4a is a graph illustrating a relationship between a DC link voltage and a command frequency during power restoration after occurrence of instantaneous power failure by inverter control according to an exemplary embodiment of the present disclosure;

FIG. 4b is a graph illustrating a relationship between a DC link voltage and an output frequency during power failure by inverter control according to an exemplary embodiment of the present disclosure;

FIG. 5 is a flowchart illustrating a method for controlling an inverter according to the present disclosure;

FIG. 6a is an experimental waveform of a DC link voltage and an experimental waveform of an output frequency during power restoration after occurrence of instantaneous power failure by inverter control according to an exemplary embodiment of the present disclosure; and

FIG. 6b is an experimental waveform of a DC link voltage and an experimental waveform of an output frequency during power failure by inverter control according to an exemplary embodiment of the present disclosure.

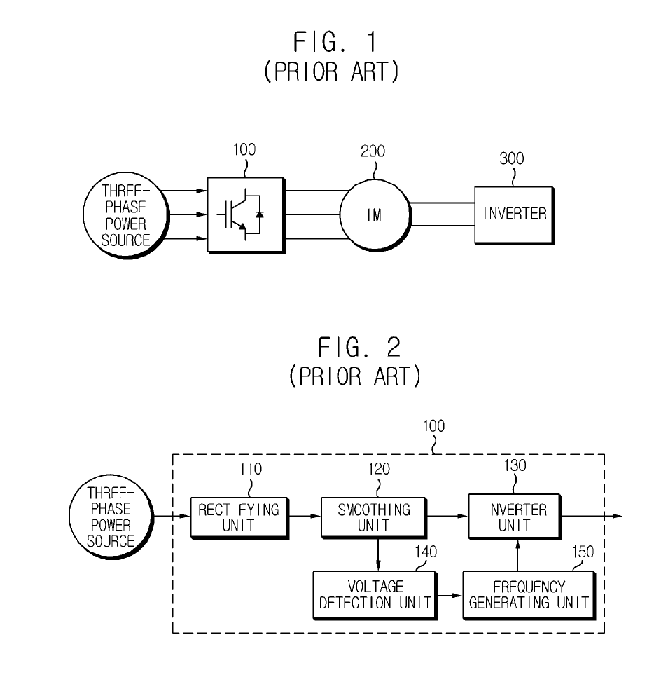

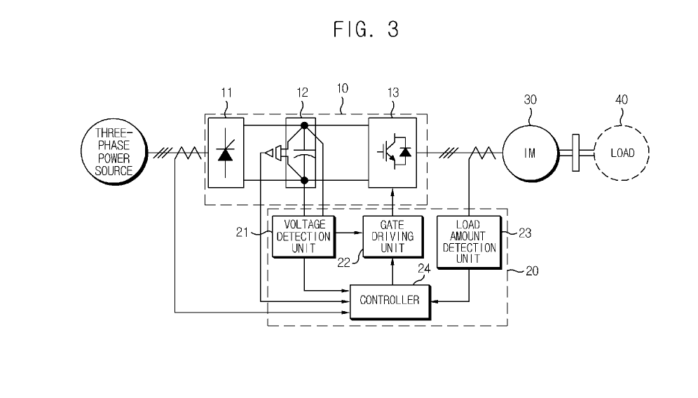

### DETAILED DESCRIPTION

Features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Hereinafter, an apparatus for controlling an inverter according to exemplary embodiments of the present disclosure will be described in detail with reference to the accompanying drawings.

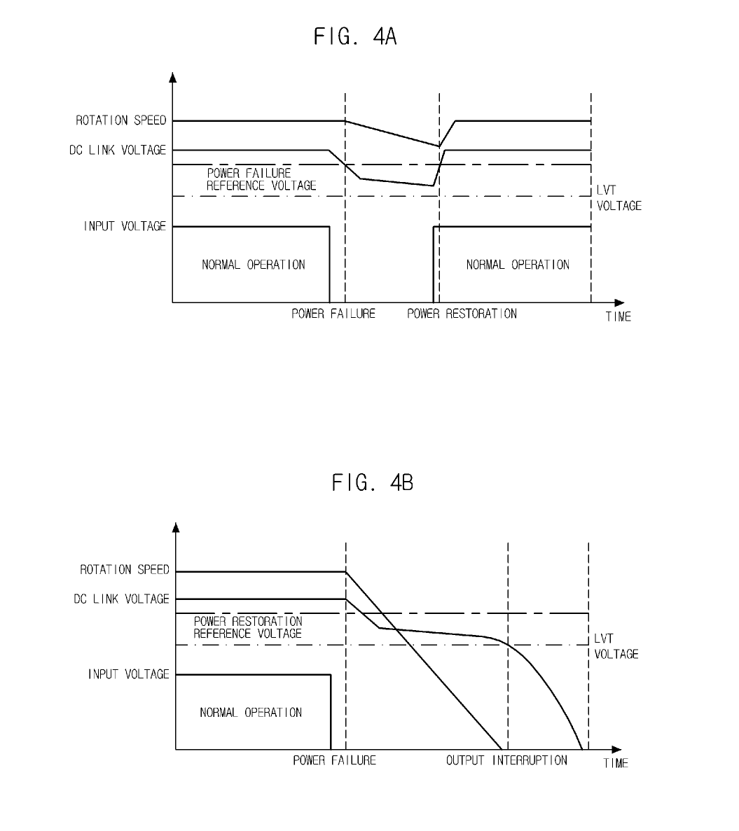

FIG. 3 is a schematic structural view of an inverter system of an inverter control device according to an exemplary embodiment of the present disclosure.

Referring to FIG. 3, an inverter system according to the present disclosure includes an inverter (10), an inverter control device (20) according to the present disclosure, an induction motor (30) and a load (40), where a three-phase AC power is applied to the inverter (10).

The inverter (10) includes a rectifying unit (11) converting an applied three-phase AC power to a DC voltage, a smoothing unit (12) reducing ripples in the converted DC voltage and an inverter unit (13) converting the DC voltage to a variable three-phase output. The DC link voltage refers to a DC voltage applied to the smoothing unit (12). Furthermore, the inverter control device (20) according to the present disclosure includes a voltage detection unit (21), a gate driving unit (22), a load amount detection unit (23) and a controller (24).

The voltage detection unit (21) detects a DC link voltage. The load amount detection unit (23) detects a load amount through an output current of the inverter unit (13). The controller (24) calculates a command voltage and a command frequency driving the induction motor (30) and provides the calculated command voltage and a command frequency to the gate driving unit (22), where the gate driving unit (22) outputs a gating signal to the inverter unit (13) based on the command voltage and the command frequency in response to control of the controller (24).

The inverter control device (20) according to the present disclosure performs a continuous operation of the inverter using the DC link voltage during instantaneous voltage drop or instantaneous power failure, and stops the inverter (10) after stopping the motor (20) during occurrence of power failure to thereby guarantee safety of a user. An operation of the inverter control device (20) according to the present disclosure is described in the following manner.

In a case there occurs an instantaneous power failure, the voltage detection unit (21) detects a DC link voltage to enable a continuous operation of the motor (30), and the load amount detection unit (23) receives an output current of the inverter (10) at the time of the power failure to detect a load amount. The load amount may be a q-axis current applied to the motor (30), for example.

The controller (24) serves to control the DC link voltage according to the load amount applied at the time of the power failure, whereby the DC link voltage is not abruptly reduced, and controls the load amount in order to render a slip frequency of the motor (30) to be near zero. That is, the controller (24) detects a load amount at the moment of the power failure at a rated speed, and deducts from a current command frequency.

In general, a rotation speed of the induction motor (30) is done by deducting a slip frequency from a command frequency. In a conventional inverter system, a command frequency is constantly maintained in a case an instantaneous power failure occurs, and the slip frequency in fact increases in response to decreased rotation speed of the induction motor (30). In a case the slip frequency increases, an energy stored in the DC link instantly disappear to give rise to control impossibility. Thus, the controller (24) according to the present disclosure arbitrarily decreases the command frequency when an instantaneous power failure occurs, to minimize a slip and maximally use the energy of the DC link.

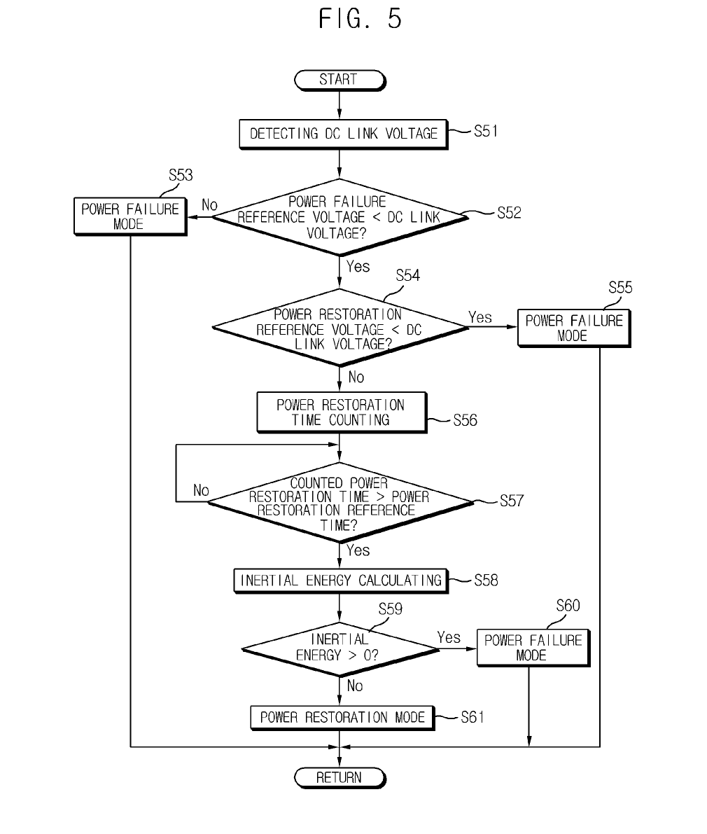

FIG. 4a is a graph illustrating a relationship between a DC link voltage and a command frequency during power restoration after occurrence of instantaneous power failure by inverter control according to an exemplary embodiment of the present disclosure.

Referring to FIG. 4a, the inverter is continuously operated using a load amount until power is stably and maximally restored through estimation of load amount below a power failure reference voltage and above an LVT level. Furthermore, the controller (24) controls the command frequency to cause a rotation speed of the motor to raise, in a case the DC link voltage rises up to the power failure reference voltage, when power is restored after occurrence of instantaneous power failure.

Meanwhile, in a case a power failure occurs in the inverter system, the induction motor (30) rotates by inertia even if an output of the inverter (10) is interrupted. Thus, the controller (24) adjusts a ratio (V/F) between a command frequency and a command voltage without interruption of the inverter (10) using the inertial energy, and reduces speed to allow the motor (30) to operate at a minimal energy.

As a result, the DC link voltage decreases, and in a case the DC link voltage decreases below the LVT level, the controller (24) interrupts an output of the inverter (10), whereby power of the inverter (10) can be interrupted in a state of the induction motor (30) being stopped.

FIG. 4b is a graph illustrating a relationship between a DC link voltage and an output frequency during power failure by inverter control according to an exemplary embodiment of the present disclosure.

Referring to FIG. 4b, in a case the instantaneous power failure is lengthened, the controller (24) according to the present disclosure reduces an output frequency until the inertial energy of the DC link voltage is completely consumed to controllably stop the inverter (10) before the DC link voltage comes to below the LVT level.

Conventionally, only the DC link voltage control was performed to cause the DC link voltage and current to severely oscillate in response to load amount and acceleration/deceleration, whereby it was difficult to stably control the inverter (10). However, according to the present disclosure, the control is made using estimation of load amount to stably control and stop the inverter, whereby the induction motor interrupts the power of the inverter (10), in a state of the induction motor (30) being stopped, to thereby guarantee safety of a user.

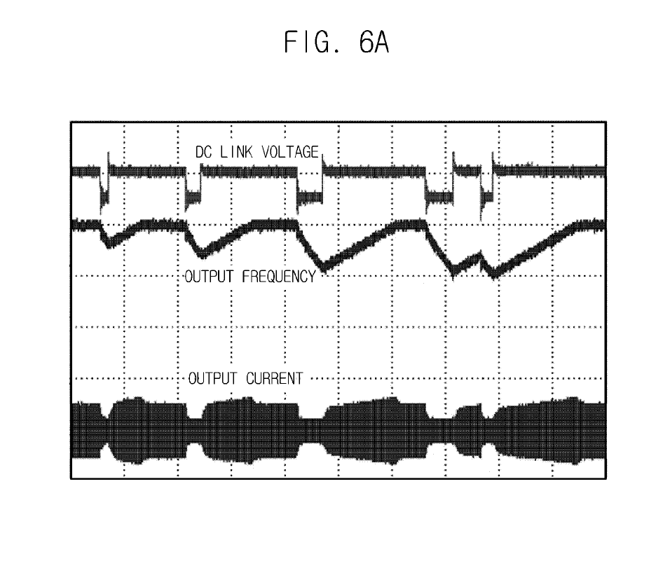

FIG. 5 is a flowchart illustrating a method for controlling an inverter according to the present disclosure, where control of the controller (24) is illustrated.

Referring to FIG. 5, the controller (24), according to a method for controlling an inverter, detects a DC link voltage to determine a normal mode, a power failure mode and a power restoration mode through comparison between the DC link voltage, a present power failure reference voltage and power restoration reference voltage.

First, a DC link voltage is detected by the voltage detection unit (21) (S51). A power failure mode is performed (S53), in a case the DC link voltage is not greater than the power failure reference voltage (S52). That is, the controller (24) changes the ratio (V/F) between the command frequency and the command voltage to allow the inertial energy of the induction motor (30) to be regenerated, and the controller (24) outputs the command frequency to the inverter unit (13), and stops the inverter (10), in a case the induction motor (30) is stopped.

Meanwhile, in a case the DC link voltage is greater than the power failure reference voltage (S52), the controller (24) determines whether the DC link voltage rises above the power restoration reference voltage after lapse of a predetermined time (S54). In this case, the controller (24) performs a normal mode control (S55).

In a case the DC link voltage is not greater than the power failure reference voltage, even after lapse of the predetermined time at S54, the controller (24) counts a power restoration time (S56). In a case the counted power restoration time is greater than the power restoration reference voltage (S57), the inertial energy (i.e., restoration amount) is calculated (S58) to perform a power failure mode control (S60) if there is any inertial energy (S59). That is, the controller (24) changes the ratio (V/F) between the command frequency and the command voltage to allow the inertial energy of the induction motor (30) to be regenerated to the inverter, whereby the command frequency is outputted to the inverter unit (13) to stop the inverter (10) in a case the induction motor (30) is stopped.

In a case there is no inertial energy at S59, the controller (24) performs a power restoration control (S61), where the controller (24) normally controls the inverter (10) in the same way as that before the power failure.

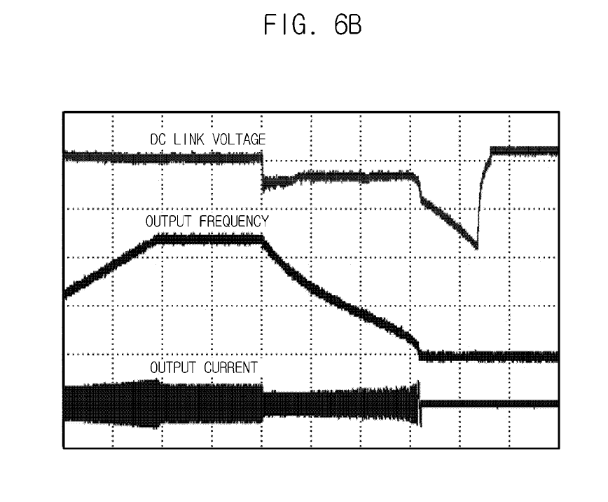

FIG. 6a is an experimental waveform of a DC link voltage and an experimental waveform of an output frequency during power restoration after occurrence of instantaneous power failure by inverter control according to an exemplary embodiment of the present disclosure, and FIG. 6b is an experimental waveform of a DC link voltage and an experimental waveform of an output frequency during power failure by inverter control according to an exemplary embodiment of the present disclosure, where the load (40) is a fan for an air conditioner.

Referring to FIG. 6a, it can be noted that a stable power restoration to a normal target frequency is made after power restoration after an instantaneous power failure within 2 seconds. Furthermore, as illustrated in FIG. 6b, even if the power failure is lengthened, a load amount is estimated to stably control the DC link voltage, whereby the DC link can be controlled until the induction motor (30) is stopped by the command frequency becoming zero (0).

As apparent from the foregoing explanation of the present disclosure, an instantaneous power failure can be compensated through voltage drop compensation to obtain reliability of the system, even if the instantaneous power failure occurs at an input terminal of an inverter.

In addition, the control by the present disclosure enables a continuous operation of an inverter by detecting a DC link voltage and a load amount during occurrence of instantaneous power failure, and enables improvement of inverter system by enhancing a control characteristic, whereby reliability of important facilities including process automation lines or semiconductor facilities that require reliability can be improved.

Meanwhile, the exemplary embodiments of the present disclosure may be embodied in the form of program code embodied in tangible media, such as magnetic recording media, optical recording media, solid state memory, floppy diskettes, CD-ROMs, hard drives, or any other non-transitory machine-readable storage medium. When the exemplary embodiments of the present disclosure are implemented using software, constituent means of the present disclosure may be code segments executing necessary processes. The programs or code segments may be also embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the disclosure.

The above-described embodiments of the present invention can also be embodied as computer readable codes/instructions/programs on a computer readable recording medium. Examples of the computer readable recording medium include storage media, such as magnetic storage media (for example, ROMs, floppy disks, hard disks, magnetic tapes, etc.), optical reading media (for example, CD-ROMs, DVDs, etc.), carrier waves (for example, transmission through the Internet) and the like. The computer readable recording medium can also be distributed over network coupled computer systems so that the computer readable code is stored and executed in a distributed fashion.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for controlling an inverter, the apparatus comprising:
a first detection unit detecting a DC link voltage of the inverter;
a second detection unit detecting a load amount from an output current outputted from the inverter to a motor; and
a controller deducting the load amount detected at the time of occurrence of instantaneous power failure from a command frequency at the time of the occurrence of instantaneous power failure to output a command voltage and a command frequency driving the motor.

2. The apparatus of claim 1, wherein the controller controls a load amount for maintaining the DC link voltage during the occurrence of instantaneous power failure from below a power failure reference voltage to above a LVT (Low Voltage Trip) level.

3. The apparatus of claim 2, wherein the controller controls the motor in such a manner that a slip frequency of the motor comes near to zero (0).

4. The apparatus of claim 1, wherein the controller reduces a rotation speed of the motor by adjusting a ratio (V/F) between a command frequency and a command voltage, in a case the DC link voltage drops below a restoration reference voltage.

5. The apparatus of claim 4, wherein the controller interrupts an output before the DC link voltage drops to below the LVT level.
